(19) United States
(12) Patent Application Publication
(10) Pub. No.: US 2010/0315805 A1
(43) Pub. Date: Dec. 16, 2010

(54) FLASHLIGHT AND LENS ASSEMBLY

(75) Inventor: ZHANG DONGPAN, Shenzhen (CN)

Correspondence Address: VENABLE LLP, P.O. BOX 34385, WASHINGTON, DC, 20043-9998, US

(73) Assignee: Microfire Technology Company, Shenzhen (CN)

(21) Appl. No.: 12/612,367

(22) Filed: Nov. 4, 2009

(30) Foreign Application Priority Data
Jun. 14, 2009 (CN) 200920132310.3
Jul. 16, 2009 (CN) 200920133611.8
Jul. 22, 2009 (CN) 200920133887.6

(51) Int. Cl. F21L 4/00; H01J 9/24

(52) U.S. Cl. 362/157; 445/23

(57) ABSTRACT

A flashlight is provided. The flashlight includes a housing having a first end and a second end. A light source is disposed at the first end of the housing. A battery is disposed in the housing. A sheath houses a plurality of lenses to focus the light. A radius of curvature for the lenses arranged farther from the light source being greater than a radius of curvature for lenses arranged closer to the light source.

### BACKGROUND OF THE INVENTION

The present invention relates generally to flashlights and more particularly to a lens assembly for flashlights and other light sources.

When commercial high power LED flashlights were first introduced, the main material used for lenses and reflecting was plastic with good transparency. The plastic was formed into a single lens with special shape and configuration by plastic injection. Now, many indoor ornamental high power LED spotlights still use this reflecting technology. However, the plastic lens is not ideal for outdoor tactical LED flashlight due to the low transparency, low rigidity, and flimsy nature of the plastic.

Flashlights with a plastic lens may emit have a flood beam and short range beam. More and more manufacturers have stopped using plastic lens. Almost all of manufacturers now use a paraboloid viewfinder to reflect the beam. Sample flashlight with a glass lens as the reflector have been provided. But these samples include technology defects and do not have practical or commercial value.

### SUMMARY OF THE INVENTION

A flashlight is provided. The flashlight comprises a housing having a lens assembly disposed at a first end, a second end opposite the first end, and a body adapted to contain at least one battery arranged between the first end and the second end; a light source, the lens assembly being arranged to focus light from the light source and including a plurality of lenses, a radius of curvature for the lenses arranged farther from the light source being greater than a radius of curvature for lenses arranged closer to the light source.

A method of making a lens assembly including a plurality of lenses and a sheath defining a plurality of grooves on an inside surface, the grooves being adapted to receive a respective one of the lenses, the method comprising: creating elastic deformation in the sheath; inserting the lenses into the respective groove while the sheath is deformed; and returning the sheath to its original shape.

A flashlight, comprising: an outer body having a stop and threads disposed at a distance from the stop; an inner body having a stop, threads disposed at a distance from the stop and at least a portion thereof slidably disposed coaxially within the outer body, the stop on the inner body and the stop an the outer body being arranged on opposite sides of the threads from each other when the threads are occlusive; at least two gliding members disposed between the outer body and the inner body.

Further objectives and advantages, as well as the structure and function of exemplary embodiments will become apparent from a consideration of the description, drawings, and examples.

### BRIEF DESCRIPTION OF THE FIGURES

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 depicts an exemplary embodiment of a flashlight;

FIG. 2 depicts a cross-section of an exemplary embodiment of a flashlight;

FIG. 3A-3B depict an exemplary embodiment of a lens assembly;

FIG. 4 depicts an exemplary embodiment of a lens arrangement; and

FIGS. 5A and 5B are a cross section of a flashlight including a lockable focus control according to an embodiment of the invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

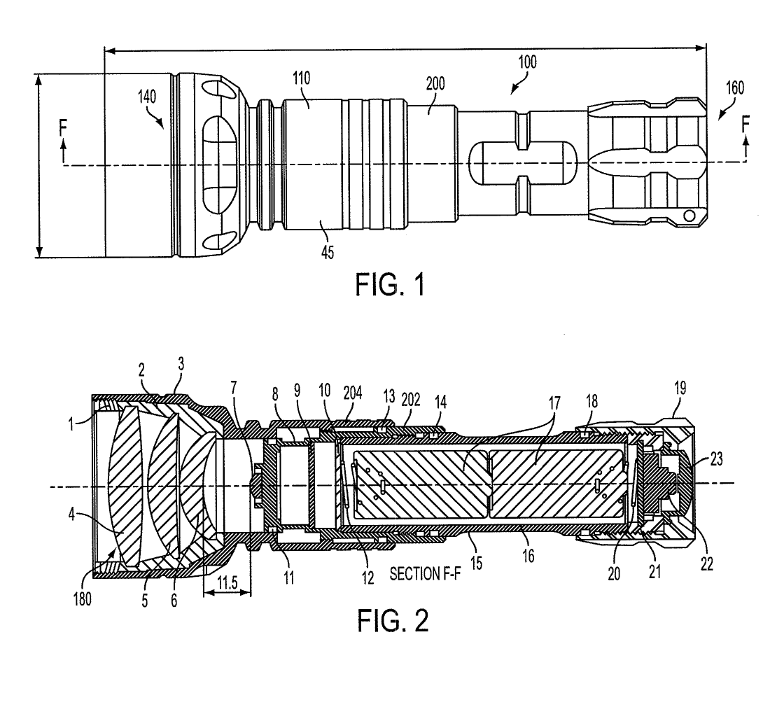

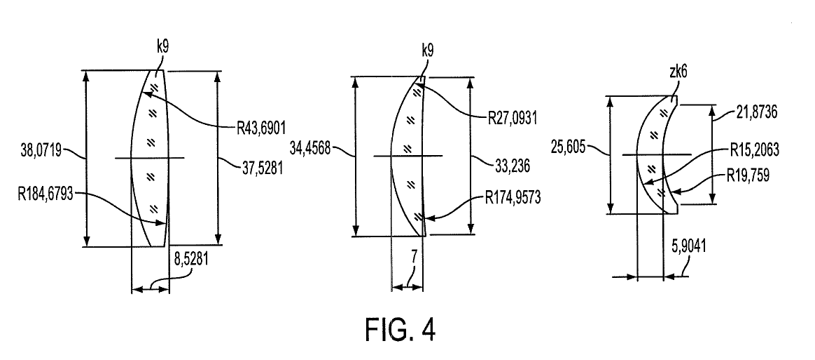

Referring to the Figures, an exemplary flashlight design 100 embodying the instant invention includes a flashlight casing or housing 110 having a light source 7 disposed at a first end 140 and having a second end 160. The first end 140 is adapted to receive a lens assembly 180. The second end 160 is typically closed. The flashlight casing may include a generally elongate body 200 defining an interior chamber. The diameter of body 200 may be substantially constant along most of its length and be adapted to accommodate the hand of a user. Body 200 can include an cylindrically shaped portion such as bezel 3, proximate end 140 to accept and accommodate the lens assembly 180. Although flashlight casing 110 is shown as having a generally tubular body 200, other configurations are anticipated, including rectangular, oval, square, or free form, so long as the basic components described herein can be accommodated. The components may also be arranged to suit the particular flashlight design. For the purposes of example only, the following discussion will refer to the embodiment shown in FIGS. 1-4.

Body 200 defines an interior chamber to receive a power supply, such as a batteries 17, and other components typically associated with a flashlight. A switch assembly 22 may be disposed within the body 20. Switch assembly 22 is configured to engage a circuit assembly 21 to turn the flashlight 100 ON and OFF. Switch assembly 22 may be a momentary push button switch and the circuit assembly 21 may include an integrated circuit, such as a microprocessor, printed circuit board or discrete circuit components. The switch assembly is preferably of a digital type, with no mechanical movement required to make the circuit connection. The movement of the momentary switch provides a signal to the circuit assembly to perform the appropriate function. Alternatively, the switch can be a slide switch or any other type of switch. A cover 23 made from a pliable material, such as rubber or the like, may be disposed over the switch assembly 22. A tail cap 19 is adapted to fit onto the second end 160 of the housing. The tail cap 19 and housing may have respective threaded surfaces to secure the tail cap 19 in place. The circuit assembly 21, switch assembly 22 and cover 23 may be disposed in the tail cap 19.

Housing 110 may be made from a variety of materials including machined steel, aluminum, or brass, but is preferably made from a polymeric material, such as high-impact acrylonitrile butadiene styrene (ABS) plastic or the like. An exterior surface 45 of casing 110 may also include texturing, channels, or other types of structures to improve the feel and grip of the flashlight by the user.

Disposed within the interior of housing 110 is light source 7. The light source 7 may include light emitting diode (LED), high power LED, incandescent, fluorescent, halogen, xenon, or other light sources capable of producing sufficient light to illuminate an object. Different from other light emitters, a high-power LED has hemispherical shiny surface and emits rays forward. The back of the LED back is an opaque heat radiation base. The light beam output from a high-power LED forms an angle. The output decreases from the center to the sides. The brightest beam is in the center of the angle, while the weakest beam is on the edge.

Light source 7 is arranged within or near the first end 140 of the housing 110. The lens assembly 180 may close the first end 140 of the housing 110.

In FIG. 2, the housing 100 may also include a battery housing 15. The batteries 17 may be disposed within the battery housing 15. A copper tube 16 may be arranged within the battery housing 15. The copper tube may be coupled to the anticathode spring 20 and circuit board 21 in the tail cap 19 at one end and to a cathode spring 12 and printed circuit board 10 at an opposite end. O-rings 11, 13, 14 and 18 may he provided to help seal the various components of the flashlight together.

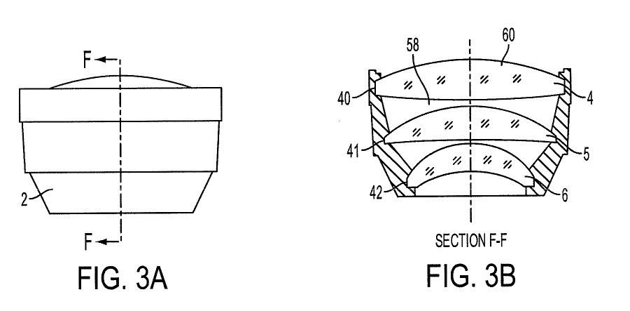

As shown in more detail in FIGS. 2, 3A and 3B, a lens ring 1 having threads engaging the bezel 3. Disposed within the lens ring 1 is a polymeric or glass lens covering. Sheath 2 may be disposed within bezel 3. The lens ring 1 may hold the sheath 2 in place within the bezel 3. One or more lenses may be disposed within sheath 2. The lenses may be glass lenses and may have an optical coating. The lenses may be configured to disperse or refract light produced by the light source 7 in a predetermined pattern, including a fresnel-type structure to focus the beam produced by light source 7. The lenses receive light emitted from light source 7 so that light produced by the light source 7 forms a beam of light emitting from the end of the flashlight. The light from light source 7 is refracted and concentrated by lens 6 to be at a smaller angle. The light passing through lens 6 is further refracted and concentrated by lens 5 to be at a smaller angle. The light passing through lens 5 is further refracted and concentrated by lens 4 to be at a smaller angle and form a focused beam. The lens assembly 180 may include the sheath 2 and lenses 4, 5, 6.

Turning now to FIGS. 3A and 3B, the sheath 2 may be disposed within the bezel 3 to secure the lenses in place. In the disclosed embodiment, the sheath 2 is used to hold three lenses 4, 5, 6 in place. However, the sheath 2 may be adapted to secure any number of lenses in place, preferably two or more lenses. The sheath 2 may define a groove(s) to receive a respective lenses. FIG. 3B illustrates a cross-section of the sheath 2. As can be seen in FIG. 3B, there are three grooves 40, 41, 42 provided. Each groove 40, 41, 42 receives a respective lens 4, 5, 6. The grooves in the sheath are arranged to secure the lenses substantially parallel and coaxial with each other. Additionally, the grooves are disposed in the sheath 2 to maintain a precise distance between the lenses. The sheath is preferably made of a semi-rigid material such as rubber, silicon gel and the like. Such a material provides a good shock resistance as well as a good fit within the bezel 3.

The sheath 2 allows for a quick and easy method to assemble the lens assembly. The sheath 2 may be pressed and drawn to create some elastic deformation. The lenses may then be inserted into their respective grooves. The sheath 2 then returns to its original shape, fixing the lenses in place. As is shown in FIG. 3B, the first lens 4 is fixed in first groove 40 the second lens 5 is fixed in the second groove 41 and the third lens 6 is fixed in the third groove 42. The sheath 2 and grooves 40, 41, 42 in the sheath 2 are sized to receive the desired lens. The dimensions of the lens, sheath and respective groove may vary depending on the specific design.

In the disclosed embodiment, three lenses 4, 5, 6 are provided in the lens assembly 180. The lenses should be arranged parallel and coaxial with each other. The radius of curvature for the surfaces of the lenses should increase as the distance from the light source increases. For example, lens 6 includes surfaces 50 and 52. Lens 5 includes surfaces 54 and 56. Lens 4 includes surfaces 58 and 60. R₁ represents the radius of curvature of the respective lens surface closest to the light source, in this case surfaces 50, 54, and 58 of lenses 6, 5, 4, respectively. R₂ represents the radius of curvature of the lens surface for each lens farthest from the light source, in this case surfaces 52, 56, and 60 of lenses 6, 5, 4, respectively. Preferably, R₁ for lens 4 is greater than R₁ for lens 5 which is greater than R₁ for lens 6. Similarly, R₂ for lens 4 is greater than R₂ for lens 5 which is greater than R₂ for lens 6.

Additionally, the diameter and thickness of the lenses should increase as the distance from the light source 7 increases. Thus, the diameter of lens 4 is greater than the diameter of lens 5 which is greater than the diameter of lens 4.

Embodiments of the invention also include a lockable focus control for the light. The body of the light 200 may include an inner tube 202 and an outer tube 201 arranged coaxial with each other as is shown in FIG. 2, for example. The inner tube 202 and the outer tube 204 are movable with respect to each other. The lens or reflectors for the light source may be movable in conjunction with the outer tube 204. The light source 7 may be movable in conjunction with the inner tube 202. The inner tube 202 and the outer tube 204 may be moved via both a threadable engagement, as well as via a slidable engagement, to change the distance between the lens in the light source 7 in order to change the focus of the flashlight. Providing two ways to change the focus of the flashlight can help maintain a precise actual distance between the light source and the lens as well as stabilizing the selected focus. Additionally, the lockable focus control may also provide easy operation and faster focusing while maintaining a coaxial relationship between the light source and the lens.

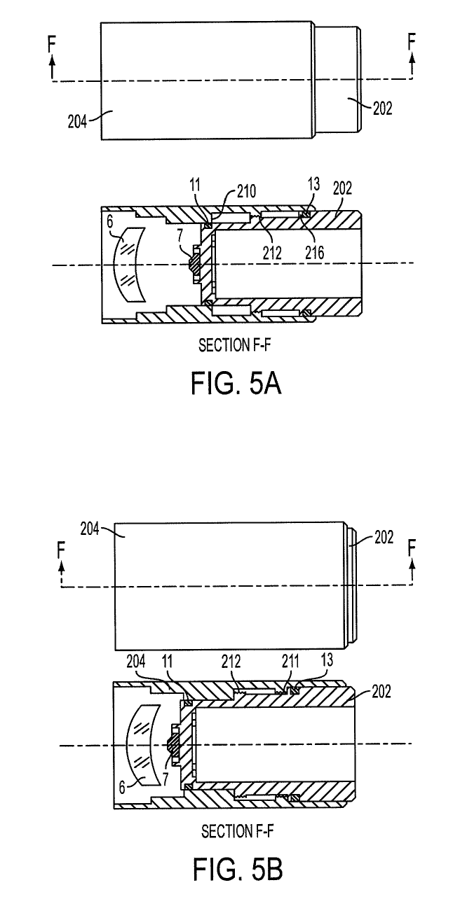

FIGS. 5A and 5B illustrate an exemplary embodiment of the lockable focus control. The inner tube 202 and may be slidable within the outer tube 204 via a plurality of gliding elements. In the disclosed embodiment, two gliding elements are provided. The gliding elements may be embodied as O rings 11 and 13. The O rings 11 and 13 are disposed between the inner tube 202 and the outer tube 204 at a longitudinal distance from each other. The outer tube 204 is provided with threads 211 on its internal surface. The inner tube 202 is provided with corresponding threads 212 on its outer surface. The inner tube 202 and the outer tube 204 are slidable with respect to each other over a gap. The gap may be defined between a stop 210 and the threads 212 on the intertube. The length of the threading on the both of the inner tube 202 and the outer tube 204 is preferably shorter than the length of the gap. The focus of the light beam may be changed by pushing and pulling the inner tube 202 and the outer tube 204 with respect to each other to change the distance of the lens 6 and the light source 7. When the threads 211 on the outer tube 204 and the threads 212 on the inner tube 202 are occlusive, the outer tube 204 may be rotated counterclockwise to engage in the threading and change the distance between the light source 7 and the lens.

Referring in more detail to FIG. 5, the state when the threads 212 on the inner tube 202 are engaged with the threads 211 on the outer tube 204, is illustrated. The outer tube may be rotated counterclockwise or clockwise to move the inner tube 202 with respect to the outer tube 204. This rotation changes the distance between the light source 7 and the lens 6 via the threading. In this state, the light is in its most focused state. The focus state is maintained steady and is not greatly effected by shock or movement to the flashlight.

Rotating the outer tube 204 counterclockwise results in the threading disengaging from each other. The outer tube 204 may then be pulled towards the inner tube 202 for a flood light like focus of the flashlight. This state of the lockable focus control is illustrated in FIG. 5B. As can be seen in FIG. 5B, the threads 212 on the inner tube 202 and the threads 211 from the outer tube 204 are disengaged from each other. The threads 211 on the outer tube 204 is now adjacent to a stop 216. The threads 212 on the inner tube 202 is adjacent to a stop 210 provided on the outer tube 204. In this state, the gap over which the inner tube 202 and outer tube 204 are slidable with respect to each other is closed.

Referring to FIG. 5A, rotating the outer tube 204 clockwise from the state when the threading is occlusive results in the outer tube 204 disengaging from the inner tube 202 such that the outer tube 204 may be removed from the flashlight.

Embodiments of the invention may provided several advantages. The traditional plastic lens is not good as it has low transparency, low rigidity, flimsy construction, and is hard to clean. And single plastic lens cannot focus the beam well and produce a short range lighting. With optical glass lens, more than 95% of the beam penetrates the lenses. As better performance and longer lifespan, the optical glass lenses combination will not effect on the performance after long-time usage. As several lenses are provided, the arrangement maybe disposed close up to High-power LED emitter. The reflector-lenses combination for High-power LED collects most of rays from LED emitter and improves the output and lengthens the range. It is an important revolution for LED illumination performance.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. For example, the functions activated by the different switches described above can also be activated by a single switch. It is therefore to be understood that, within the scope of the claims and their equivalents, the invention may be practiced otherwise than as specifically described.

What is claimed is:

1. A flashlight, comprising;
a housing having a lens assembly disposed at a first end, a second end opposite the first end, and a body adapted to contain at least one battery arranged between the first end and the second end;
a light source, the lens assembly being arranged to focus light from the light source and including a plurality if lenses, a radius of curvature for the lenses arranged farther from the light source being greater than a radius of curvature for lenses arranged closer to the light source.

2. The flashlight of claim 1, wherein the light source a light emitting diode (LED).

3. The flashlight of claim 1, wherein the lenses are arranged parallel and coaxial with each other.

4. The flashlight of claim 1, further comprising a cover disposed over the light source.

5. The flashlight of claim 1, wherein the lens assembly includes a sheath holding the lenses.

6. The flashlight of claim 1, wherein the sheath defines a plurality of grooves on an inside surface, the grooves being adapted to receive a respective one of the lenses.

7. The flashlight of claim 6, wherein the sheath is comprised of rubber or silica gel.

8. The flashlight of claim 1, wherein a diameter of lenses arranged farther from the light source is greater than a diameter for lenses arranged closer to the light source.

9. The flashlight of claim 1, wherein the sheath is a unitary structure.

10. The flashlight of claim 1, wherein the grooves are parallel and coaxial with each other.

11. A method of making a lens assembly including a plurality of lenses and a sheath defining a plurality of grooves on an inside surface, the grooves being adapted to receive a respective one of the lenses, the method comprising:
creating elastic deformation in the sheath;
inserting the lenses into the respective groove while the sheath is deformed; and
returning the sheath to its original shape.

12. A flashlight, comprising:
an outer body having a stop and threads disposed at a distance from the stop;
an inner body having a stop, threads disposed at a distance from the stop and at least a portion thereof slidably disposed coaxially within the outer body, the stop on the inner body and the stop an the outer body being arranged on opposite sides of the threads from each other when the threads are occlusive;
at least two gliding members disposed between the outer body and the inner body.
